(19) United States
(12) Patent Application Publication
(10) Pub. No.: US 2026/0264617 A1
(43) Pub. Date: Sep. 10, 2026

(54) AUTOMATIC RETRACTABLE STEPS FOR THE REAR EMERGENCY DOOR OF A SCHOOL BUS

(71) Applicant: Marcus Banks, Indianapolis, IN (US)

(72) Inventor: Marcus Banks, Indianapolis, IN (US)

(73) Assignee: Step Safe Innovations LLC, INDIANAPOLIS, IN (US)

(21) Appl. No.: 19/665,731

(22) Filed: May 1, 2026

Related U.S. Application Data
(60) Provisional application No. 63/641,949, filed on May 2, 2024.
(60) Provisional application No. 63/804,970, filed on May 13, 2025.

(51) Int. Cl. B60R 3/02; B60J 5/10; G07C 5/08

(52) U.S. Cl. CPC B60R 3/02; B60J 5/108; G07C 5/0816

(57) ABSTRACT

An automatic retractable step system for school bus rear emergency doors employs event-triggered deployment logic responsive to emergency door latch actuation, distinguishing it from generic vehicle step systems. The system includes retractable steps, a continuous drive actuator, and a door latch sensor that generates an event-triggered signal upon latch actuation. In the simplest embodiment, an electrical circuit directly connects the door latch sensor to the actuator, providing immediate deployment upon latch actuation without requiring a separate control system. In alternative embodiments, a control system may be interposed to provide safety interlocks evaluating ignition and transmission status prior to deployment. The event-triggered activation provides immediate deployment synchronized with emergency exit activation, enhancing safety during evacuations by ensuring steps are deployed before students attempt egress.

### CROSS-REFERENCE TO RELATED APPLICATIONS

This application claims the benefit of U.S. Provisional Patent Application No. 63/641,949, filed May 2, 2024 and 63/804,970 filed May 13, 2025, entitled “AUTOMATIC RETRACTABLE STEPS FOR THE REAR EMERGENCY DOOR OF A SCHOOL BUS,” the entire contents of which are incorporated herein by reference.

### BACKGROUND

### Field of the Invention

The present invention relates to school bus safety equipment, and more particularly to automatic retractable step systems with event-triggered deployment responsive to emergency door latch actuation for facilitating safe evacuation at rear emergency doors of school buses.

### Description of the Related Art

School buses transport millions of students daily and are designed with specific safety features mandated by federal and state regulations. A typical school bus includes a front entrance door with integrated steps and a rear emergency exit door. The rear emergency door serves a critical function during evacuation procedures, allowing students to exit quickly in emergency situations.

However, conventional school bus designs present a significant safety issue at the rear emergency door. Unlike the front entrance, the rear emergency door typically lacks integrated steps, creating a substantial height difference between the door threshold and the ground surface. This height difference, often exceeding two feet, presents a considerable safety hazard during both routine and emergency egress situations.

The absence of steps at the rear door can lead to various accidents and injuries. Students, particularly younger children or those with physical disabilities, face difficulty navigating the height difference. Common injuries include slips, trips, falls, sprains, bruises, and fractures. The risk increases significantly in adverse weather conditions where ground surfaces may be slippery, or during emergency evacuations where panic and urgency compound the danger.

Prior art solutions to address this problem have proven inadequate. Some systems employ manual portable steps or ramps that must be deployed by bus drivers or attendants. These manual assistive devices suffer from several deficiencies. First, manual deployment requires significant time and effort from bus personnel, causing delays in both routine operations and emergency evacuations. During emergencies requiring rapid evacuation, the time needed to manually deploy steps can be life-threatening.

Second, manual devices require storage space when not in use, reducing available storage for other necessary equipment. Third, manual deployment systems are prone to human error—drivers may forget to deploy steps, or may deploy them incorrectly, creating additional hazards. Fourth, manually deployed steps may not be consistently positioned at the optimal height or angle, leading to variability that itself creates tripping hazards.

Various automatic step systems exist in the prior art, particularly in the field of retractable running boards and vehicle access steps classified under International Patent Classification B60R 3/02 (arrangements of steps or ladders facilitating access to or on vehicle). For example, powered running boards are known for pickup trucks and SUVs, motorized steps are known for recreational vehicles, and automated entrance steps are known for commercial buses and motorhomes.

Prior art automatic retractable step systems exist for recreational vehicles, motorhomes, and travel trailers. These systems, such as the Kwikee 25 Series manufactured by Lippert Components, typically employ a simple door switch that detects whether the vehicle entry door panel has moved from a closed position to an open position. Upon detecting door panel opening, an electric motor extends the steps; when the door panel closes, the steps retract. Such RV step systems are designed primarily for user convenience in camping and recreational settings, where a single user or small family enters and exits the vehicle at leisure.

These prior art RV step systems are inadequate for school bus emergency egress applications for several reasons. First, school buses operate under Federal Motor Vehicle Safety Standard (FMVSS) 217, which mandates specific requirements for rear emergency exits designed to facilitate rapid evacuation of multiple students during emergency situations. Unlike RV applications where the primary concern is user convenience, school bus rear emergency doors must enable swift egress of numerous students, often under stressful conditions. Second, existing RV step systems typically employ an ignition override system that automatically retracts steps whenever the vehicle ignition is turned on, without regard to whether the vehicle is actually in motion or safely stationary. While this approach is acceptable for recreational vehicles where the ignition is only activated when preparing to drive, it creates a safety hazard for school buses during emergency evacuations where the driver may need to keep the engine running to maintain electrical systems, climate control, or hazard lights while the bus remains stationary with the transmission in Park. Third, prior art RV step systems rely on door panel position switches that only detect step deployment after the door has already begun opening, creating a timing lag where the door may be partially or fully open before steps are fully extended to the ground. This timing delay is unacceptable for school bus emergency egress where students may attempt to exit immediately upon door opening, before steps have reached their deployed position. The present invention addresses these deficiencies through event-triggered door latch sensing and, in some embodiments, transmission status monitoring and safety interlock logic specifically designed for school bus emergency egress requirements.

Generally speaking, generic vehicle step systems classified under B60R 3/02 lack the specific automation logic and safety interlocks required for school bus emergency door applications. Prior art systems, while providing powered retractable steps for various vehicles, do not teach or suggest event-triggered automation specifically responsive to emergency door latch actuation. These systems typically employ simple proximity sensors, weight sensors, or manual switches that are not integrated with emergency door mechanisms and do not provide immediate triggering synchronized with emergency exit activation.

Furthermore, prior art vehicle step systems lack the comprehensive safety interlocks necessary for school bus environments. School buses operate in unique conditions requiring specific safeguards: (1) steps must not deploy while the vehicle is moving or the engine is operational with transmission engaged, to prevent injury during transit; (2) steps must deploy rapidly and reliably during emergency evacuations, without manual intervention that could delay egress; (3) steps must integrate with driver-accessible dashboard controls allowing manual override for testing, maintenance, and non-standard situations; and (4) steps must provide security features preventing unauthorized access when the bus is parked and unattended.

Generic vehicle step systems typically lack integration with vehicle ignition systems, transmission status sensors, or dashboard-mounted override controls. These systems are designed for routine access to vehicles such as RVs and trucks, not for emergency evacuation scenarios where rapid automatic deployment without driver intervention is critical.

Additionally, prior art vehicle step systems are not adapted for the unique requirements of school bus rear emergency doors. Rear emergency doors must remain unobstructed for rapid egress, steps must withstand outdoor exposure throughout the vehicle's operational life in harsh school bus environments, and the system must integrate with existing emergency door latch mechanisms without compromising emergency functionality or violating Federal Motor Vehicle Safety Standards governing school bus emergency exits.

Therefore, there exists a long-felt but unsolved need for an automatic retractable step system specifically designed for school bus rear emergency doors that: (1) employs event-triggered automation responsive to emergency door latch actuation; (2) optionally integrates safety interlocks including ignition override and transmission status monitoring; (3) optionally provides dashboard-mounted manual controls accessible to the driver; (4) enhances student safety during both routine and emergency egress; and (5) eliminates the deficiencies of both manual assistive devices and generic prior art vehicle step systems.

### SUMMARY OF THE INVENTION

The present invention addresses the deficiencies of prior art systems by providing an automatic retractable step system specifically designed for rear emergency doors of school buses, featuring event-triggered deployment logic responsive to emergency door latch actuation.

In its simplest form, the invention provides an automatic retractable step system for a school bus rear emergency door, comprising: a plurality of retractable steps configured to transition between a stowed position and a deployed position; a continuous drive actuator operatively connected to the retractable steps; a door latch sensor configured to detect actuation of a latch mechanism of the rear emergency door and to generate an event-triggered signal; and an electrical circuit connecting the door latch sensor to the continuous drive actuator, wherein the continuous drive actuator is configured to receive a power signal and deploy the retractable steps in response to the event-triggered signal from the door latch sensor.

In alternative embodiments, a control system may be interposed between the door latch sensor and the continuous drive actuator to provide additional safety interlock functionality. Such a control system may evaluate ignition status information, transmission status information, or other vehicle parameters prior to permitting deployment.

The continuous drive actuator may comprise an electric motor powered by the vehicle's electrical system, or alternatively, a pneumatic actuator powered by compressed air. The retractable steps are constructed from heavy-gauge steel or alloy steel and include anti-slip surfaces to enhance traction in various weather conditions.

The system may further include handrails attached to the steps, integrated lighting to enhance visibility during nighttime operations, and obstacle detection sensors that automatically halt or reverse step movement if an obstruction is detected.

In another aspect, the invention provides a method for facilitating safe egress from a school bus rear emergency door, comprising: detecting actuation of a latch mechanism of a rear emergency door of a school bus via a door latch sensor and generating an event-triggered signal; generating a power signal to a continuous drive actuator in response to the event-triggered signal; automatically deploying a plurality of retractable steps from a stowed position to a deployed position; and automatically retracting the plurality of retractable steps upon detecting re-engagement of the latch mechanism.

The invention provides numerous advantages over prior art systems, including: (1) event-triggered automation synchronized with emergency door latch actuation, eliminating manual deployment steps and human error; (2) optional safety interlocks preventing deployment during vehicle operation; (3) optional dashboard-accessible manual override for driver control; (4) consistent and reliable step positioning at optimal height and angle; (5) enhanced safety through automatic operation requiring no driver intervention during emergency evacuations; (6) improved emergency evacuation capability through rapid automatic deployment; (7) weatherproof construction ensuring reliable operation in school bus environments; (8) integration with existing bus electrical systems; and (9) compliance with school bus safety regulations and standards.

Additional features and advantages of the invention will be apparent from the detailed description which follows.

### BRIEF DESCRIPTION OF THE DRAWINGS

The accompanying drawings illustrate preferred embodiments of the invention and, together with the description, serve to explain the principles of the invention.

FIG. 1 is a rear elevation view showing the automatic retractable step system in a deployed position.

FIG. 1A is a rear elevation view showing the automatic retractable step system according to another embodiment in a deployed position.

FIG. 2 is a rear elevation view showing the automatic retractable step system in a retracted position.

FIG. 2A is a rear elevation view showing the automatic retractable step system according to another embodiment in a retracted position.

FIG. 3 is a detailed view of the continuous drive actuator.

FIG. 4 is an isometric view showing the retractable step assembly with mounting hardware.

FIG. 4A is an isometric view showing the retractable step assembly according to another embodiment.

FIG. 5 is an enlarged detail view showing the door latch sensor installation on the latch mechanism.

FIG. 6 is a side elevation view of the school bus showing the rear emergency door area and step assembly.

FIG. 6A is a side elevation view of the school bus according to another embodiment.

FIG. 7 is a detail view of the driver's dashboard area showing the manual override interface.

FIG. 8 is a schematic block diagram illustrating the control system architecture.

FIG. 9 is a flowchart diagram illustrating a method for facilitating safe egress from the school bus rear emergency door.

### DETAILED DESCRIPTION OF PREFERRED EMBODIMENTS

The present invention will be described with reference to the accompanying drawings, which show preferred embodiments by way of illustration. It will be understood that the invention is not limited to these specific embodiments and that variations and modifications may be made without departing from the scope of the invention as defined in the appended claims.

### General System Architecture

As used herein, ‘emergency egress signal’ refers to any signal generated in response to actuation of the latch mechanism 15 that causes or permits deployment of the retractable steps 20. In the direct-connection embodiment, the emergency egress signal comprises electrical power supplied to the continuous drive actuator 40 when the door latch sensor 50 completes the electrical circuit upon latch actuation. In embodiments employing a control system 60, the emergency egress signal comprises a control signal generated by the control system 60 after evaluating one or more input conditions. The emergency egress signal may also be referred to herein as an event-triggered signal or deployment signal.

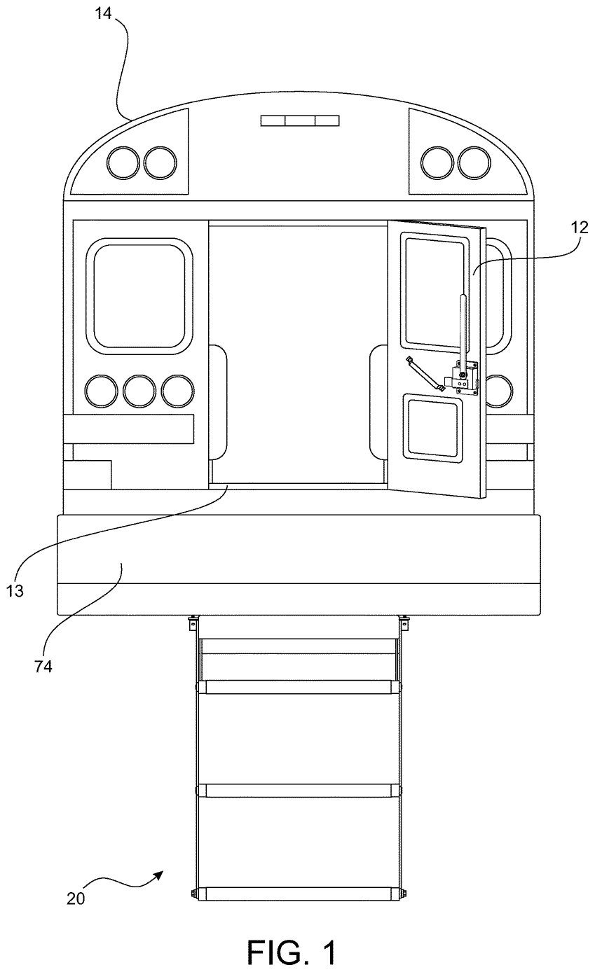

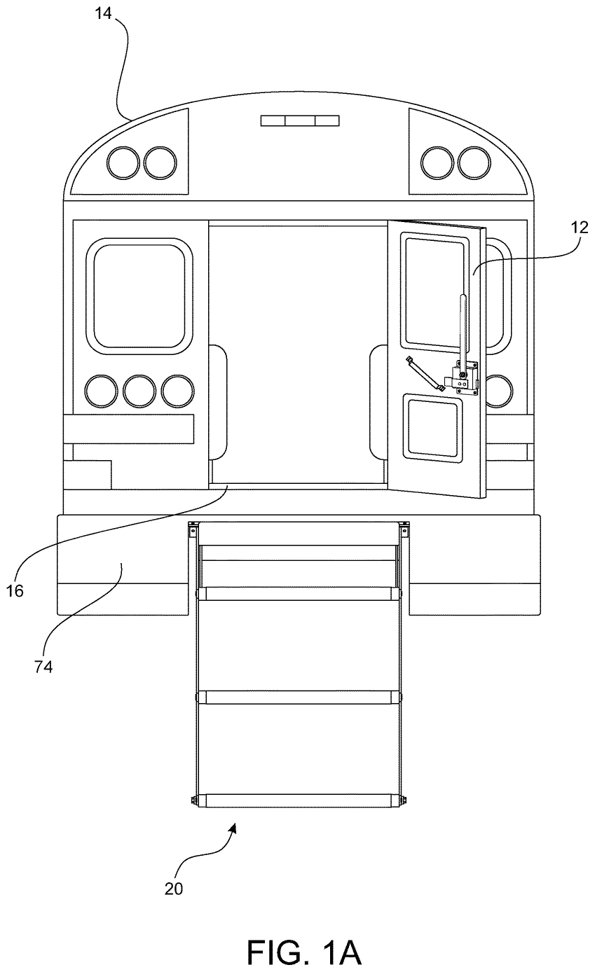

The automatic retractable step system 10 may be provided as a standalone assembly that is mounted to the underside of the bus floor or door frame using mounting brackets, adapters, or other suitable connectors. In an alternative embodiment, automatic retractable step system 10 may be integrated with the rear bumper structure of the school bus 14, as shown in embodiments in FIGS. 1A, 2A, 4A and 6A or. In non-integrated embodiments, the step assembly may be positioned beneath the door threshold 13 and secured to the bus chassis or body structure independently of the rear bumper 74. The choice between integrated and non-integrated configurations may depend on factors such as the specific bus model, the available mounting space, whether the system is being installed during original bus manufacture or as a retrofit to an existing vehicle, and the preferences of the bus operator. Both configurations utilize the same fundamental components and operational principles described herein, including the retractable steps 20, continuous drive actuator 40, c, and door latch sensor 50.

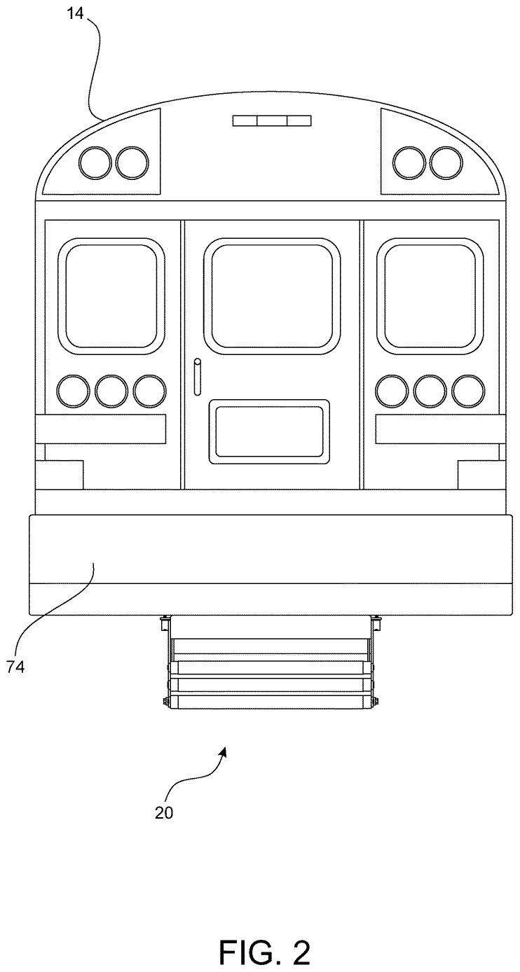

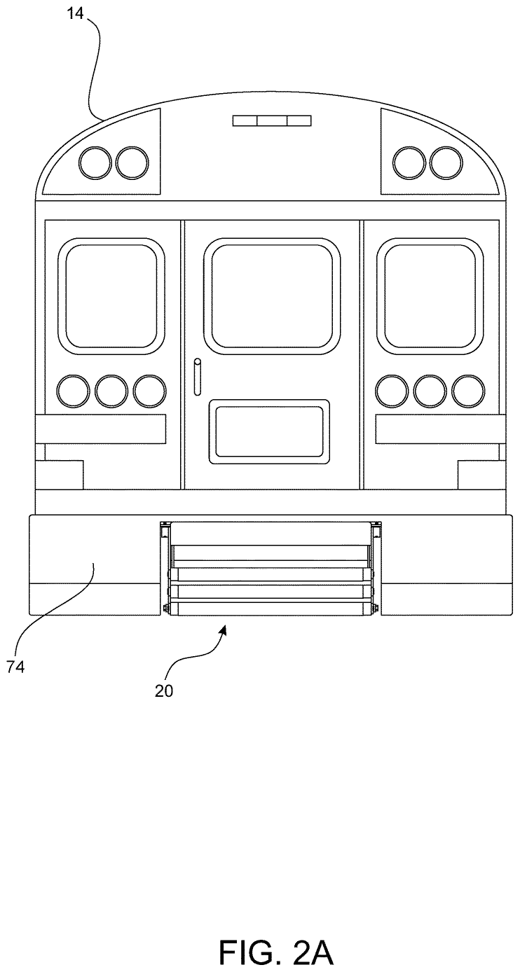

Referring to embodiments shown in FIGS. 1 and 1A, an automatic retractable step system 10 according to the present invention is installed at a rear emergency door 12 of a school bus 14. The system 10 comprises a plurality of retractable steps 20 that automatically deploy when the rear emergency door 12 is opened, as shown in FIGS. 1 and 1A, and automatically retract when the rear emergency door 12 is closed, as shown in FIGS. 2 and 2A.

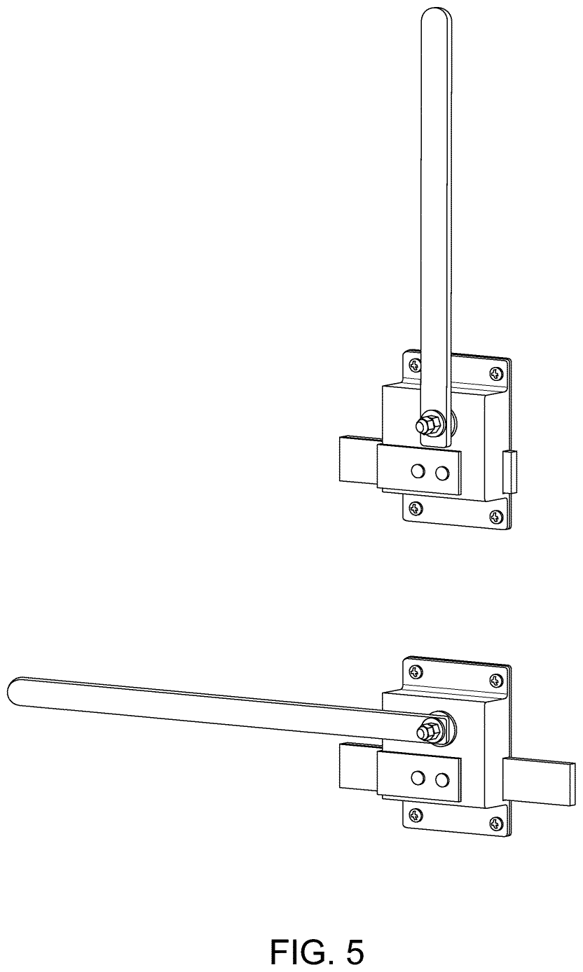

The school bus 14 includes a conventional body structure with windows 16, seats (not shown), and the rear emergency door 12 positioned at the rear of the vehicle. The rear emergency door 12 typically opens outward and includes a latch mechanism 15 (shown in detail in FIG. 5) as required by federal and state school bus regulations. The latch mechanism 15 may comprise a paddle-type latch, lever latch, or other emergency exit release mechanism complying with Federal Motor Vehicle Safety Standard (FMVSS) 217.

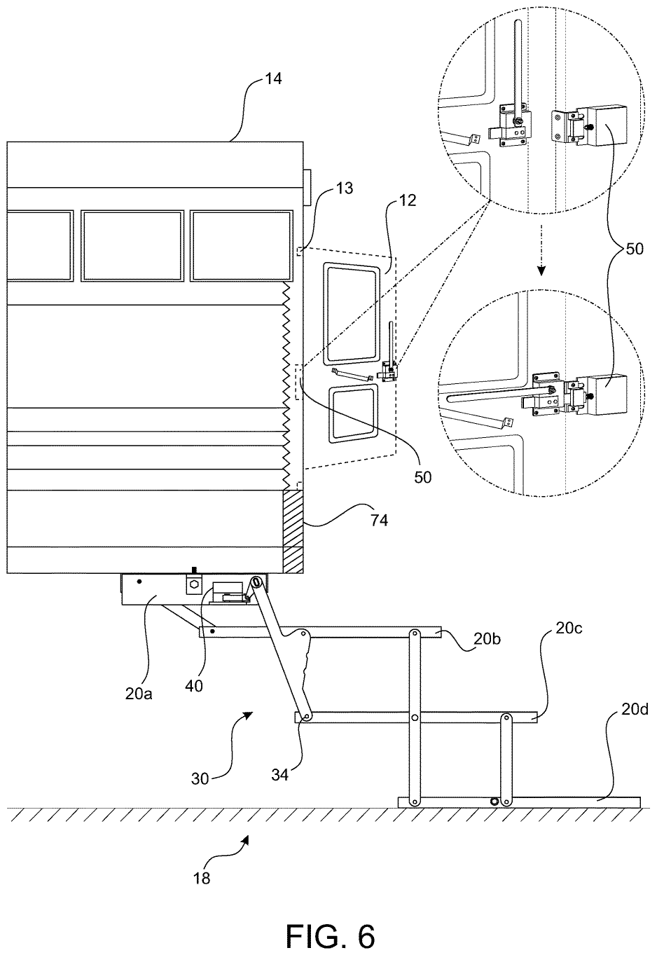

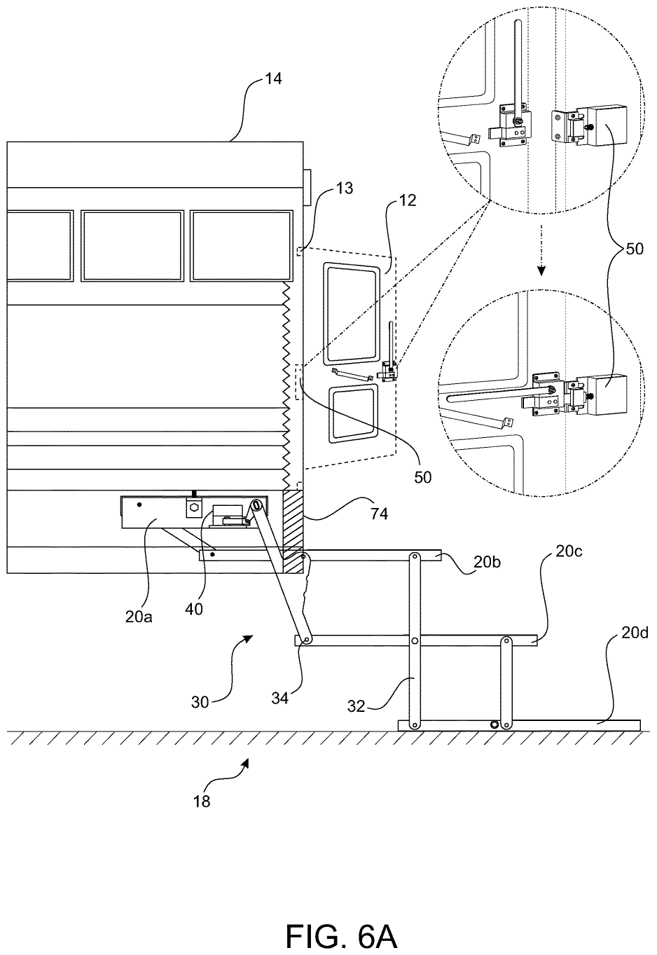

As shown in embodiments depicted in FIGS. 1, 1A, 6, and 6A, the retractable steps 20 extend from a retracted position adjacent to a door threshold 13 of the rear emergency door 12 to an extended position providing stepped access from the door threshold 13 to a ground surface 18.

### Retractable Step Assembly

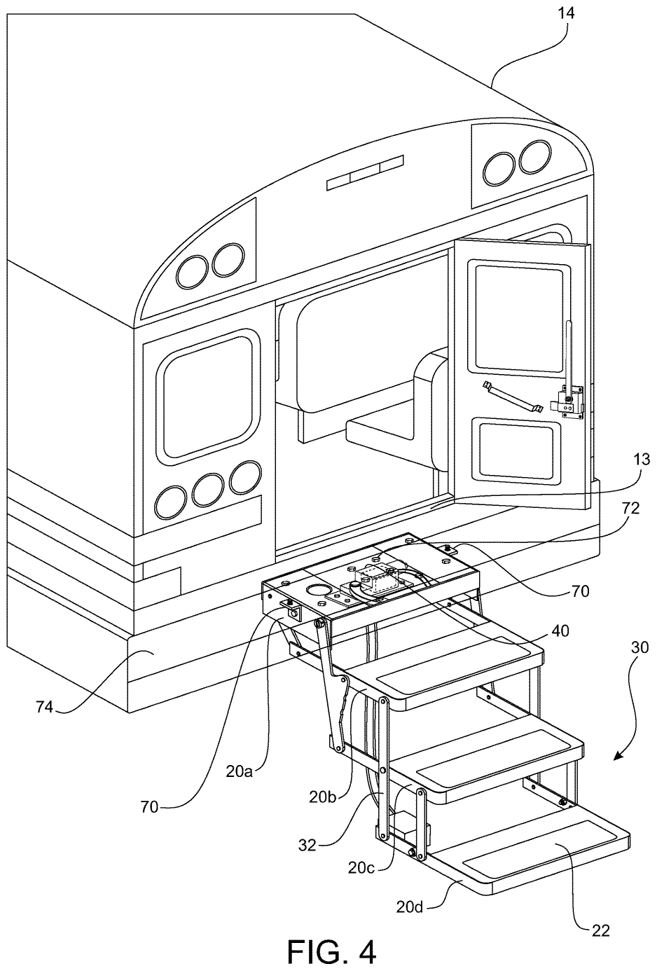

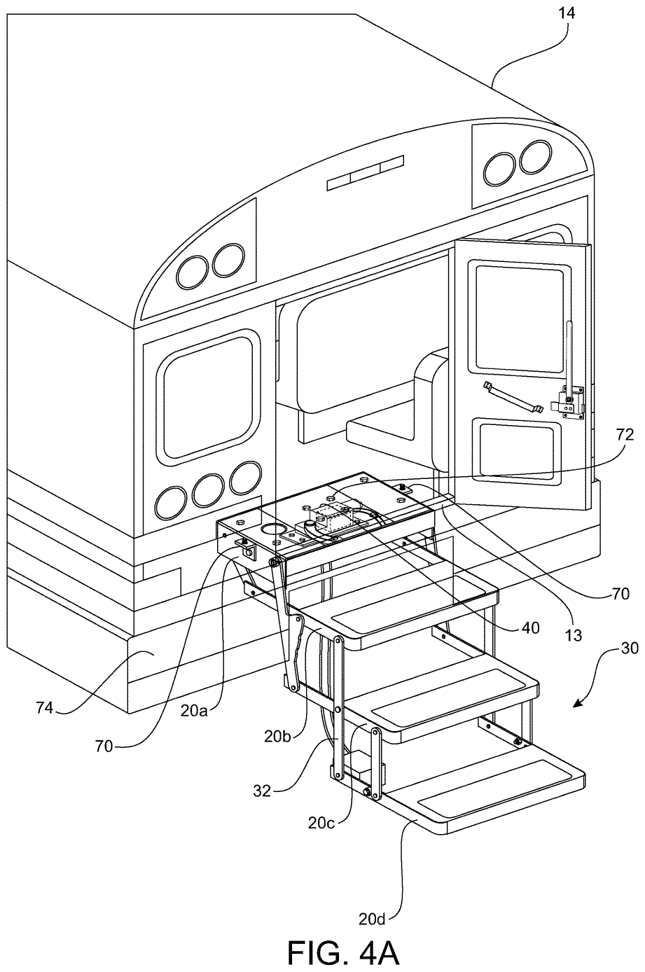

Referring to embodiments shown in FIGS. 4, 4A, 6, and 6A, the retractable step assembly may comprise a plurality of individual steps 20a, 20b, 20c, 20d arranged in a foldable configuration. While embodiments shown depict four individual steps, a person of ordinary skill in the art will understand that the plurality of retractable steps may comprise two, three, four, five, or more individual steps depending on factors including the height of the rear emergency door threshold above the ground, the specific bus model, ground clearance requirements, and applicable safety regulations, with the optimal number of steps being readily determinable by one of ordinary skill in the art.

Each individual step 20a-20d comprises a tread surface 22 and a riser 24. The tread surface 22 is preferably formed from heavy-gauge steel or alloy steel and includes an anti-slip texture or coating 26 to enhance traction. In the preferred embodiment, the anti-slip texture 26 comprises a raised pattern, diamond plate texture, or rubberized coating that provides grip in wet, icy, or muddy conditions commonly encountered in school bus operations.

The dimensions of each step are selected to comply with applicable building codes and safety standards. In embodiments, each step may have a tread width of approximately 24 inches and a tread depth of approximately 11 to 12 inches. In exemplary embodiments, the step rise is approximately 8 inches. Such dimensions are chosen to provide comfortable and safe egress for students ranging from elementary to high school age, as well as for individuals with varying physical abilities.

Each step 20a-20d has a load capacity sufficient to support the weight of multiple students simultaneously. In the preferred embodiment, each step is rated to support at least 300 pounds, with the overall assembly rated to support at least 600 pounds distributed across multiple steps. The structural components are designed with appropriate safety factors to ensure reliability throughout the operational lifetime of the school bus.

### Linkage Mechanism

The individual steps 20a-20d are interconnected by a linkage mechanism 30 that allows the steps to fold into a compact retracted position and unfold into an extended deployed position. As shown in FIGS. 4 and 4A, the linkage mechanism 30 may comprise a plurality of pivot arms 32 connecting adjacent steps.

Each pivot arm 32 is pivotally connected at a first end to a first step and at a second end to an adjacent step. The pivot connections 34 allow relative rotation between adjacent steps, enabling the folding and unfolding action. In embodiments as shown, the pivot arms 32 may comprise paired arms on opposite sides of each step to provide balanced support and ensure uniform deployment.

The pivot connections 34 comprise pivot pins or pivot shafts extending through aligned apertures in the steps 20a-20d and pivot arms 32. Bearings, preferably comprising stainless steel bushings or sealed ball bearings, are provided at the pivot connections 34 to reduce friction and wear. The bearings are selected for outdoor operation and are resistant to dirt, moisture, and temperature extremes encountered in school bus environments.

In the retracted position, the steps 20a-20d are folded substantially parallel to each other, creating a compact package with a folded height of approximately 9 to 10 inches. This compact configuration allows the retracted steps to fit within or closely adjacent to the door threshold 13 without protruding significantly from the bus body.

In the extended position shown in FIGS. 1, 1A, 6, and 6A, the steps 20a-20d are unfolded to create a stairway with successive steps positioned at appropriate rise intervals. The deployed steps extend downward from the door threshold 13 approximately 21 to 22 inches to reach near or to the ground surface 18, depending on the specific bus model and ground clearance.

### Continuous Drive Actuator

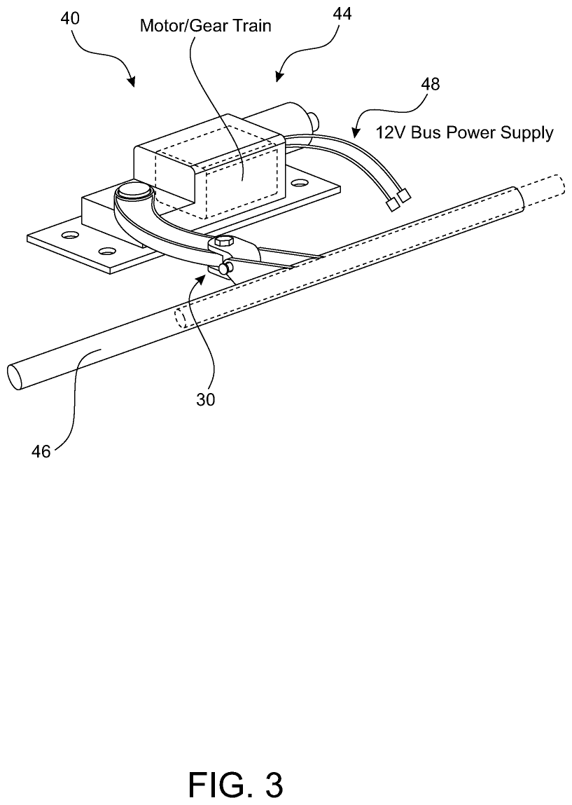

Referring to embodiments shown in FIG. 3, a continuous drive actuator 40 is operatively connected to the retractable step assembly to provide the motive force for deploying and retracting the steps 20. The continuous drive actuator 40 is preferably an electric motor, though pneumatic actuators are also contemplated within the scope of the invention.

The continuous drive actuator 40 is configured to provide rapid deployment of the retractable steps 20 to ensure safe egress timing. In embodiments, the continuous drive actuator 40 transitions the plurality of retractable steps 20 from the stowed position to the fully deployed position in less than 5 seconds, preferably less than 3 seconds, from the moment the door latch sensor 50 generates the event-triggered signal. This rapid deployment timing ensures that by the time students reach the opened rear emergency door 12 and prepare to exit (typically 2-4 seconds after actuating the latch mechanism 15), the retractable steps 20 have reached the ground surface and are fully deployed to receive egress. The continuous drive actuator 40 may comprise an electric motor with sufficient torque and speed characteristics to achieve this deployment timing, a pneumatic cylinder system supplied by compressed air from the school bus air brake system, or a hydraulic actuator system. The specific actuator type is less critical than the functional requirement that deployment occurs rapidly enough to prevent students from encountering partially deployed or stowed steps during emergency evacuation.

In embodiments, the continuous drive actuator 40 transitions the plurality of retractable steps 20 from the stowed position to the fully deployed position in less than five seconds, and preferably in less than three seconds, from generation of the emergency egress signal.

In embodiments employing an electric motor, the actuator 40 may comprise a 12-volt DC motor compatible with the vehicle's electrical system. The motor 40 may be a brushed or brushless DC motor selected based on torque requirements, durability, and environmental resistance. The motor 40 is housed in a weatherproof enclosure 42 rated for outdoor exposure, including resistance to rain, snow, road salt, and temperature extremes ranging from- 40° F. to 150° F. typical in school bus operations.

The motor 40 is connected to the step assembly through a drive mechanism 44, which may comprise a gear train, a threaded drive shaft, a rack and pinion system, or a cable and pulley system. In one embodiment shown schematically in FIG. 3, the drive mechanism 44 comprises a linear actuator with an extending and retracting drive rod 46 connected to the uppermost step 20a or to a linkage point on the step assembly. As the drive rod 46 extends, it unfolds the step assembly into the deployed position; as the drive rod 46 retracts, it folds the step assembly into the retracted position.

The motor 40 is electrically connected to the bus's 12-volt electrical system through sealed weatherproof electrical connections 48. Power is supplied from the bus battery or alternator, and appropriate circuit protection (fuses or circuit breakers) is provided.

In an alternative embodiment, the continuous drive actuator comprises a pneumatic motor or cylinder powered by compressed air. A compressed air supply (either from an onboard air compressor or from the bus's air brake system) provides pneumatic power to extend and retract a pneumatic cylinder connected to the step assembly. Pneumatic systems offer advantages in terms of robustness and resistance to shock and vibration, though they require additional components including air lines, valves, and pressure regulators.

### Door Latch Sensor and Event-Triggered Activation

A key aspect of the present invention is the integration of event-triggered activation logic responsive to emergency door latch actuation, distinguishing the system from generic prior art vehicle step systems that employ simple proximity sensors or manual switches. Referring to embodiments shown in FIGS. 5, 6, and 6A, a door latch sensor 50 is mounted on or adjacent to the latch mechanism 15 of the rear emergency door 12 to detect actuation of the latch mechanism 15.

The door latch sensor 50 is configured to detect actuation of the latch mechanism 15 rather than merely detecting whether the door panel 12 has moved to an open position. This distinction is critical for ensuring timely deployment of the retractable steps 20 during school bus emergency egress situations. In embodiments, the door latch sensor 50 comprises a limit switch, proximity sensor, Hall effect sensor, or magnetic reed switch positioned on or adjacent to the latch mechanism 15 such that mechanical actuation of the latch paddle or latch lever by a person triggers the sensor substantially instantaneously. The door latch sensor 50 may be mechanically coupled to the latch linkage, mounted on the latch housing with an actuator arm contacting the latch paddle, or positioned such that movement of the latch mechanism 15 from its engaged position toward its disengaged position activates the sensor. This event-triggered sensing approach enables the system to detect egress intent at the moment the latch mechanism 15 is actuated—that is, before the rear emergency door 12 has substantially opened or moved from its closed position. This timing is a concerte improvement over systems known in the art which only trigger after the door panel has moved a threshold distance from the closed position. By detecting latch actuation rather than door panel position, the present invention ensures that deployment of the retractable steps 20 is initiated immediately upon detection of egress intent, enabling the steps to reach their fully extended position by the time students begin exiting through the opened door. In school bus emergency evacuation scenarios where multiple students may be attempting to exit rapidly and simultaneously, this timing advantage prevents students from encountering partially deployed or stowed steps, thereby reducing the risk of falls, injuries, or evacuation delays.

In embodiments, the door latch sensor 50 may comprise a limit switch mechanically coupled to the latch mechanism 15 such that movement of the latch paddle or lever directly actuates the switch. Because the latch mechanism 15 must be actuated to release the door before the door can begin to open, the limit switch is triggered at the moment of latch actuation, prior to any substantial opening movement of the door itself. This mechanical sequence—wherein latch actuation necessarily precedes door movement—enables the door latch sensor 50 to generate the event-triggered signal before the rear emergency door 12 has substantially opened, allowing step deployment to begin immediately upon emergency exit activation rather than after the door reaches a predetermined open angle. In another embodiment, the door latch sensor 50 may comprise a magnetic reed switch positioned adjacent to a magnetic element attached to a moving component of the latch mechanism 15, wherein movement of the latch component during actuation changes the magnetic field and triggers the reed switch before the door itself moves. In yet another embodiment, the door latch sensor 50 may comprise an optical sensor or proximity sensor configured to detect movement of latch components during actuation, again triggering before substantial door movement occurs due to the mechanical sequence of latch release preceding door opening.

The critical distinction from prior art is that the door latch sensor 50 provides event-triggered activation—the sensor generates a triggering signal at the moment the emergency door latch is actuated, before the door has substantially opened. This event-triggered approach ensures that step deployment begins immediately upon emergency exit activation, minimizing delay between door latch release and availability of deployed steps for egress.

This event-triggered activation is particularly important in emergency evacuation scenarios where every second counts. By triggering deployment at the moment of latch actuation rather than after the door has opened to a certain angle (as in generic prior art systems), the present invention provides deployed steps more rapidly, potentially saving critical seconds during emergency egress.

### Direct Electrical Connection Embodiment

The system includes circuitry configured to generate the emergency egress signal. The circuitry may comprise a door latch sensor electrically connected to the actuator, or may comprise a control system including electronic circuitry such as a microcontroller, programmable logic controller, or relay logic.

In the simplest embodiment, the door latch sensor 50 is electrically connected directly to the continuous drive actuator 40 such that actuation of the latch mechanism 15 completes an electrical circuit providing a power signal to the actuator 40, causing immediate deployment of the retractable steps 20. In this direct-connection embodiment, no separate control system or logic evaluation is required—the mechanical act of actuating the latch mechanism 15 directly triggers step deployment via the electrical circuit.

Specifically, the door latch sensor 50 may comprise a switch that closes an electrical circuit when the latch mechanism 15 is actuated, thereby providing electrical power from the school bus 12-volt power supply to the continuous drive actuator 40. Upon receiving power, the actuator 40 immediately begins deploying the retractable steps 20. When the latch mechanism 15 is subsequently re-engaged (indicating door closure), the door latch sensor 50 opens or reverses the electrical circuit, causing the actuator 40 to retract the steps 20.

This direct-connection embodiment provides the simplest and most reliable configuration, with minimal components and no programmable logic that could fail or require calibration. The event-triggered activation is achieved purely through the mechanical coupling of the door latch sensor 50 to the latch mechanism 15 and the electrical connection to the actuator 40.

Retraction of the retractable steps 20 occurs upon termination of the emergency egress signal. In the direct-connection embodiment, termination occurs when the latch mechanism 15 is re-engaged and the door latch sensor 50 opens the electrical circuit, thereby ceasing electrical power flow to the continuous drive actuator 40. Upon termination of the emergency egress signal, the continuous drive actuator 40 retracts the steps 20 to the stowed position.

### Control System Embodiment with Safety Interlocks

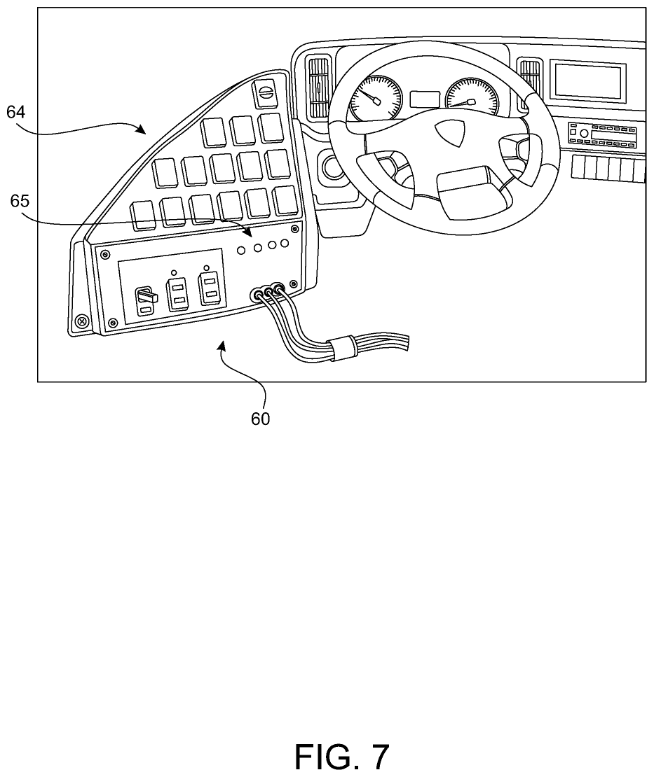

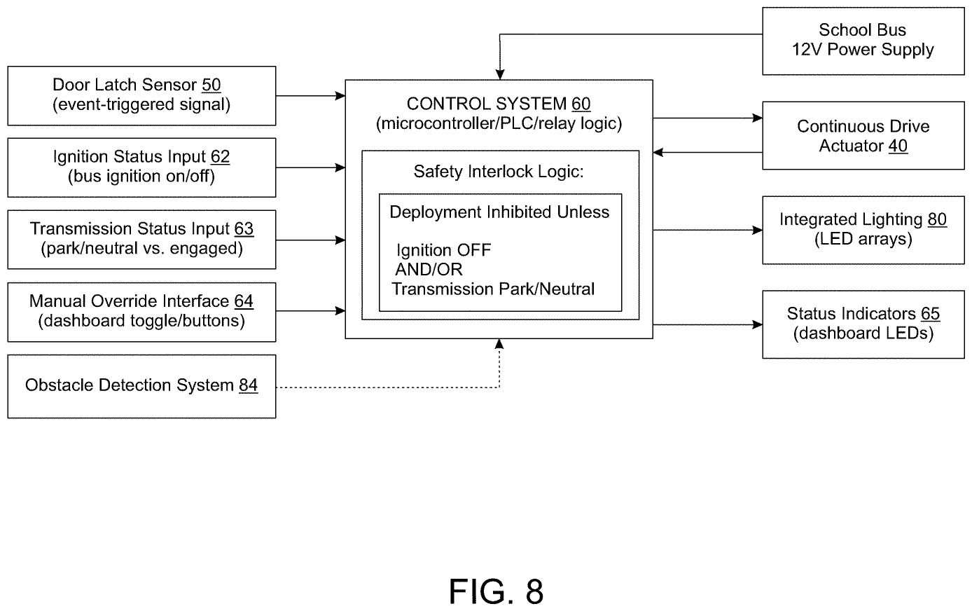

In alternative embodiments, a control system 60 may be interposed between the door latch sensor 50 and the continuous drive actuator 40 to provide additional safety interlock functionality. Referring to embodiments shown in FIGS. 7, 8 and 9, the control system 60 may be implemented as a dedicated control module, integrated with the bus's existing vehicle control electronics, body control module, or onboard computer system.

The control system 60 may comprise electronic circuitry including a microcontroller, programmable logic controller (PLC), or relay logic configured to receive signals from the door latch sensor 50 and generate control signals to the continuous drive actuator 40.

A distinguishing feature of the control system embodiment is the integration of comprehensive safety interlock logic specifically tailored to school bus operational requirements. The control system 60 may implement multiple safety interlocks.

In operation, when the door latch sensor 50 detects actuation of the emergency door latch mechanism 15, it sends an event-triggered activation signal to the control system 60. The control system 60 may then evaluate multiple safety conditions before activating deployment.

The control system 60 may include ignition interlock logic that prevents step deployment when the vehicle is in an operational state. Specifically, an ignition status input 62 provides the control system 60 with information regarding whether the vehicle ignition is in the “on” position. Additionally, a transmission status input 63 may provide information regarding whether the vehicle transmission is engaged in a driving gear (forward or reverse).

In addition to ignition status information 62, the control system 60 may be configured to receive transmission status information 63 from the school bus transmission system. The transmission status information 63 indicates whether the transmission is in Park, Neutral, Drive, Reverse, or another engaged gear position. The control system 60 may evaluate transmission status information 63 in combination with ignition status information 62 to determine whether deployment of the retractable steps 20 is safe. Specifically, the control system 60 may permit deployment when the ignition is in an ON state provided that the transmission is in Park or Neutral position, indicating the vehicle is stationary even though the engine is running. This transmission status interlock is useful for school bus emergency evacuation scenarios where the bus driver may need to maintain engine operation to power electrical systems, climate control, emergency flashers, or communication equipment while students evacuate through the rear emergency door 12. In such scenarios, the bus remains safely stationary with the transmission in Park, making step deployment safe despite the ignition being ON. This functionality differs fundamentally from prior art RV step systems that employ a rigid ignition override wherein steps automatically retract whenever the ignition is turned ON, regardless of transmission status or vehicle motion. The transmission status input 63 may be obtained from the vehicle CAN bus, transmission control module, gear position sensor, or a dedicated transmission position switch. In embodiments, the safety interlock logic of the control system 60 inhibits deployment when the ignition is ON and the transmission is in any forward or reverse gear (Drive, Reverse, Low, etc.), but permits deployment when the ignition is ON and the transmission is in Park or Neutral.

If the ignition status input 62 indicates the ignition is “on” and the transmission status input 63 indicates the transmission is engaged, the control system 60 prevents deployment of the steps 20 even if the door latch sensor 50 detects emergency door latch actuation. This safety interlock prevents dangerous deployment of steps while the bus is moving or capable of moving, which could cause injury to students or damage to the step assembly.

This ignition and transmission interlock logic is useful for school bus applications where doors might be accidentally actuated during transit, or where driver error might result in attempting to move the vehicle with the emergency door open. Generic prior art vehicle step systems designed for RVs, trucks, and other applications do not incorporate this school bus-specific safety logic because they are designed for stationary deployment scenarios.

Only when safety conditions are satisfied (ignition off or transmission in park/neutral) does the control system 60 respond to the event-triggered signal from the door latch sensor 50 by activating the continuous drive actuator 40 to deploy the steps 20. The deployment process typically requires 2-5 seconds, providing rapid access without significant delay.

When the door latch sensor 50 subsequently detects that the rear emergency door 12 has been re-latched (indicating door closing), it sends a retraction signal to the control system 60. In response, the control system 60 activates the continuous drive actuator 40 in the reverse direction to retract the steps 20. The retraction process likewise requires 2-5 seconds to return the steps to their compact storage position.

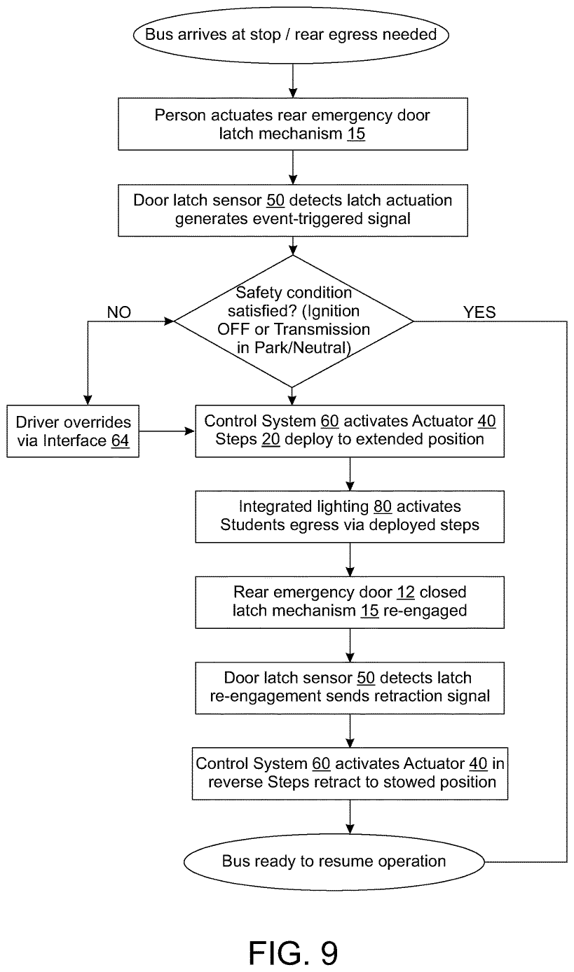

Referring to FIG. 9, a method for facilitating safe egress from the school bus rear emergency door is illustrated. Upon actuation of the latch mechanism 15, the door latch sensor 50 detects the actuation and generates an event-triggered signal. In embodiments employing a control system 60, the control system evaluates whether a safety condition is satisfied, such as whether the ignition is OFF or the transmission is in Park or Neutral. If the safety condition is satisfied, or if a driver override is received via manual override interface 64, the control system 60 activates the continuous drive actuator 40 to deploy the retractable steps 20. In embodiments, upon re-engagement of the latch mechanism 15, the door latch sensor 50 generates a retraction signal, and the steps 20 return to the stowed position.

### Dashboard-Mounted Manual Override Control

In embodiments employing a control system 60, the control system 60 may include a manual override interface 64 comprising a manual override switch or control panel mounted on the driver's dashboard or accessible from the driver's position, as shown in FIG. 7.

The manual override interface 64 allows the driver to manually deploy or retract the steps independent of the automatic event-triggered operation. This feature is useful for several school bus-specific scenarios: (1) testing the system before beginning a route; (2) situations where automatic operation is not desired, such as when the bus is parked for an extended period; (3) recovering from any malfunction or unusual condition; and (4) training and demonstration purposes.

In one embodiment, the manual override interface 64 comprises a three-position toggle switch (Deploy-Off-Retract) or a pair of momentary push buttons (Deploy/Retract). The driver can activate manual deployment or retraction regardless of the door latch sensor 50 status, providing positive driver control over the system.

Importantly, the manual override interface 64 may be subject to the same safety interlock logic as the automatic operation. Even when the driver manually activates deployment via the manual override interface 64, the control system 60 may evaluate the ignition status input 62 and transmission status input 63, preventing deployment if the vehicle is in an operational state. This ensures that even manual override cannot defeat the critical safety interlocks.

The integration of dashboard-mounted manual override controls distinguishes the control system embodiment from generic prior art vehicle step systems that either lack manual controls entirely or provide only local controls adjacent to the step assembly itself. For school bus applications, driver-accessible dashboard controls are useful because the driver may need to control and monitor the step system from the driver's position without leaving the driver's seat.

Additionally, the control system 60 may include status indicators 65 visible to the driver, such as LED indicators on the dashboard showing whether steps are deployed, retracted, deploying, or in an error condition. This real-time status feedback enhances driver awareness and operational safety.

### Mounting and Integration

Referring to embodiments as shown in FIGS. 1,2,4 and 6, the retractable step system 10 may be mounted to the bus body through mounting brackets 70 and fasteners 72. In these illustrated embodiments, the mounting brackets 70 are secured to a bracket fastened to the underside chassis of the bus. The mounting brackets 70 are formed from steel or aluminum and are designed to withstand the static and dynamic loads imposed by students using the steps, as well as road shock and vibration experienced during vehicle operation.

The fasteners 72 may comprise bolts, screws, or rivets appropriate for the bus body construction. In some bus models with steel bodies, the fasteners 72 comprise bolts threaded into welded nuts or into the bus frame members. In buses with aluminum or composite bodies, appropriate fasteners for those materials are selected.

As shown in FIGS. 1A, 2A, 4A, and 6A, in alternative embodiments, the retracted step assembly is housed within or immediately adjacent to the rear bumper 74. This integration provides a clean appearance when the steps are retracted and protects the step mechanism from impact damage. The rear bumper 74 may be modified or specially designed to accommodate the step system, including providing a recess or compartment for the retracted steps.

In another embodiment, the step assembly is mounted directly to the underside of the door threshold 13, with the steps folding upward against the door frame when retracted. This configuration eliminates the need for bumper integration and may be preferable for retrofit installations on existing buses.

### Additional Features

The automatic retractable step system 10 may include various optional features to enhance safety, visibility, and functionality.

Lighting System: Integrated lights 80 may be provided on or adjacent to the steps 20. In embodiments the lights 80 are LED lights powered by the vehicle electrical system and configured to illuminate automatically when the steps are deployed. The lights 80 enhance visibility during nighttime operations and in low-light conditions, reducing the risk of missteps. In embodiments, the lights 80 are positioned along the edges of each step tread surface 22 to clearly delineate the step boundaries.

Handrails: Retractable or fixed handrails 82 may be provided adjacent to the steps 20 to provide additional support for students during boarding and egress. In one embodiment, the handrails 82 are attached to the sides of the door frame and extend downward alongside the deployed steps. The handrails 82 may be fixed or may be configured to deploy and retract in coordination with the steps 20.

An obstacle detection system 84 may be provided to enhance safety during step deployment and retraction. The obstacle detection system 84 may comprise sensors such as proximity sensors, pressure sensors, optical sensors, or infrared sensors configured to detect objects or persons in the path of the deploying or retracting steps. School bus emergency egress scenarios present unique safety challenges not present in generic vehicle access applications: multiple students may egress simultaneously in close proximity, younger students may not be aware of moving step mechanisms, and emergency evacuation scenarios may involve crowded, fast-paced egress where students' attention is focused on rapid exit rather than avoiding moving equipment. If an obstacle is detected during deployment or retraction, the system may immediately halt the actuator 40 and may reverse the movement to avoid pinching or impacting the obstruction, preventing injuries to students who may be standing near or on the steps during deployment or retraction. This safety feature is particularly important in school bus applications where steps must deploy rapidly during emergency evacuations while students are in close proximity, addressing a safety concern not present in generic prior art vehicle step systems designed for controlled, single-user access scenarios in recreational vehicles and trucks.

Anti-Slip Features: As previously described, the tread surfaces 22 include anti-slip textures or coatings 26. These may be raised diamond plate patterns, rubberized coatings, or adhesive anti-slip tapes. The anti-slip features 26 are selected for durability in outdoor conditions and resistance to wear from repeated use and exposure to road debris, salt, and cleaning chemicals.

Weatherproofing: All electrical components including the motor 40, door latch sensor 50, and electrical connections 48 are housed in weatherproof enclosures rated to IP65 or higher standards. Sealed connectors prevent moisture ingress, and all exposed metal surfaces are treated with corrosion-resistant coatings or constructed from stainless steel or aluminum to withstand exposure to rain, snow, road salt, and cleaning chemicals typical in school bus operations.

### Operational Sequence with Event-Triggered Activation

The operation of the automatic retractable step system 10 will now be described with reference to a typical use scenario, emphasizing the event-triggered activation feature that distinguishes the invention from prior art. When the school bus 14 arrives at a location requiring rear door egress, the driver or an authorized person actuates the emergency door latch mechanism 15 to release the rear emergency door 12. At the moment the latch mechanism 15 is actuated, the door latch sensor 50 immediately detects the latch actuation and generates an event-triggered signal.

In the direct-connection embodiment, this event-triggered signal directly provides power to the continuous drive actuator 40, which immediately begins deploying the steps 20. The motor 40 drives the linkage mechanism 30, causing the folded steps 20a-20d to unfold from the compact retracted position to the extended deployed position, with the deployment process completing within approximately 2-5 seconds.

In the control system embodiment, upon receiving the event-triggered activation signal, the control system 60 may evaluate safety interlock conditions by checking the ignition status input 62 and transmission status input 63. Assuming the bus engine is off or the transmission is in park/neutral (typical for evacuation scenarios), the safety interlock conditions are satisfied, and the control system 60 activates the continuous drive actuator 40 to deploy the steps 20.

After all students have exited and egress is complete, the rear emergency door 12 is closed and the latch mechanism 15 is re-engaged. As the latch engages, the door latch sensor 50 detects the latch state change and initiates retraction.

In the direct-connection embodiment, the change in the door latch sensor 50 state directly causes the actuator 40 to retract the steps 20.

In the control system embodiment, the door latch sensor 50 sends a retraction signal to the control system 60, which activates the continuous drive actuator 40 in the reverse direction to retract the steps 20.

The retraction process completes within approximately 2-5 seconds, returning the steps to their stowed configuration where they do not protrude from the bus body.

### Alternative Embodiments

While the foregoing description details preferred embodiments employing folding steps with a linkage mechanism and event-triggered activation, alternative embodiments are contemplated within the scope of the invention.

Telescoping Steps: In alternative embodiments, the steps comprise telescoping sections that extend and retract linearly rather than folding. Each step slides within the step above it, similar to a telescope or extending ladder, allowing the step assembly to extend to the deployed position and retract to a compact stored position. The event-triggered activation remains applicable to this telescoping configuration.

Ramp Configuration: In another alternative embodiment, the step system comprises an integrated ramp-step hybrid. The structure includes both ramped surfaces and stepped surfaces, providing accessibility for individuals with mobility devices (wheelchairs, walkers) while also providing conventional steps for ambulatory users. The automatic event-triggered deployment applies equally to this ramp-step configuration.

Electric-Powered Ramp: In a further alternative embodiment, the step system is replaced with a fully ramped surface similar to those used in accessibility-equipped vehicles. The ramp deploys from a retracted position within or adjacent to the door to an extended position reaching the ground, providing a sloped surface for egress. The event-triggered activation distinguishes this embodiment from generic vehicle ramps.

Bumper Integration: As shown in FIGS. 1A, 2A, 4A, and 6A, the step assembly may be fully integrated within a modified rear bumper 74. The bumper 74 includes a recess or compartment housing the retracted steps, and a movable bumper panel may cover the recess when the steps are retracted. Upon deployment triggered by emergency door latch actuation, the panel moves and the steps extend downward from the bumper.

Pneumatic Actuation: As described previously, the continuous drive actuator 40 may comprise a pneumatic cylinder or motor rather than an electric motor. Pneumatic actuation uses compressed air from the vehicle's air brake system or from a dedicated air compressor to extend and retract the step assembly.

### Security Features

The automatic retractable step system 10 may include security features to prevent unauthorized access to the bus when parked or unattended.

In one embodiment employing a control system 60, the control system 60 may include interior/exterior detection logic. A secondary sensor or switch (not shown) detects whether the emergency door latch 15 is being actuated from the interior of the bus or from the exterior. If the latch is actuated from the interior (authorized egress), the system deploys the steps normally. If the latch is actuated from the exterior (potential unauthorized access), the system does not deploy the steps, making it more difficult for unauthorized persons to enter the bus via the rear door.

Alternatively, or additionally, in embodiments employing a control system 60, the control system 60 may require authentication or authorization before deploying steps. For example, a keypad, RFID reader, or other access control device may be integrated with the control system 60. Steps deploy only after valid credentials are presented, preventing unauthorized use.

### Maintenance and Reliability

The automatic retractable step system 10 is designed for reliable operation with minimal maintenance over the operational lifetime of the school bus (typically 12-15 years and 150,000-200,000 miles). The moving components including the linkage mechanism 30, pivot connections 34, and bearings are designed for thousands of deployment and retraction cycles typical in school bus service, with sealed bearings 36 and weatherproof construction minimizing maintenance requirements. Periodic lubrication of pivot points may be performed during routine bus maintenance intervals (e.g., annually or every 12,000 miles).

The continuous drive actuator 40, particularly when implemented as an electric motor, is selected for reliability and durability in harsh school bus environments, and may incorporate internal limit switches or position sensors to prevent over-extension or over-retraction. The electrical components including the door latch sensor 50 and wiring 48 are sealed against moisture and contaminants, ensuring reliable operation in all weather conditions encountered in school bus service.

In embodiments employing a control system 60, the control system 60 may include self-diagnostic capabilities that periodically test the door latch sensor 50, actuator 40, and other components, alerting the driver to any detected faults before they result in operational failures.

### Modifications and Variations

While the invention has been described with reference to specific preferred embodiments, it will be understood by those skilled in the art that various changes may be made and equivalents may be substituted for elements thereof without departing from the scope of the invention. For example, different types of actuators, linkage mechanisms, materials, sensors, and control system implementations may be employed while remaining within the scope of the appended claims, provided the event-triggered activation responsive to emergency door latch actuation is maintained. The invention is not limited to school buses but may be adapted for use on other types of vehicles having emergency doors or evacuation exits where event-triggered deployment is beneficial, including commercial buses, shuttle buses, emergency vehicles, and specialty vehicles.

As used herein, the terms “comprises,” “comprising,” “includes,” “including,” “has,” “having,” or any other variation thereof, are intended to cover a non-exclusive inclusion. For example, a system that comprises a list of components is not necessarily limited to only those components but may include other components not expressly listed.

While particular embodiments have been illustrated and described, it will be apparent that various modifications can be made without departing from the spirit and scope of the invention as defined in the appended claims.

What is claimed is:

1. An automatic retractable step system for facilitating emergency egress from a rear emergency door of a school bus, comprising:
a plurality of retractable steps configured to transition between a stowed position and a deployed position;
a continuous drive actuator operatively connected to the plurality of retractable steps;
circuitry configured to generate an emergency egress signal in response to at least actuation of a latch mechanism of the rear emergency door; and
wherein the continuous drive actuator is configured to deploy the plurality of retractable steps in response to the emergency egress signal and retract the plurality of retractable steps upon termination of the emergency egress signal.

2. The system of claim 1, wherein the circuitry comprises a door latch sensor positioned adjacent to the latch mechanism and electrically connected to the continuous drive actuator, and wherein the emergency egress signal comprises electrical power supplied to the continuous drive actuator when the latch mechanism is actuated.

3. The system of claim 2, wherein the door latch sensor comprises a switch configured to complete an electrical circuit upon actuation of the latch mechanism, thereby supplying electrical power from a vehicle power supply to the continuous drive actuator.

4. The system of claim 2, wherein the door latch sensor comprises at least one of a limit switch, a proximity sensor, a Hall effect sensor, or a magnetic reed switch.

5. The system of claim 1, wherein the circuitry comprises a control system configured to evaluate actuation of the latch mechanism and at least one of ignition status information or transmission status information prior to generating the emergency egress signal.

6. The system of claim 5, wherein the control system generates the emergency egress signal when the ignition status information indicates ignition is off, or when the ignition status information indicates ignition is on and the transmission status information indicates the transmission is not engaged in a driving gear.

7. The system of claim 5, wherein the control system inhibits generation of the emergency egress signal when the ignition status information indicates ignition is on and the transmission status information indicates the transmission is engaged in a driving gear.

8. The system of claim 1, further comprising a manual override interface accessible from a driver position, wherein the manual override interface is configured to generate the emergency egress signal independent of the latch mechanism.

9. The system of claim 1, wherein the emergency egress signal is generated before the rear emergency door has substantially opened from a closed position.

10. The system of claim 1, wherein the continuous drive actuator transitions the plurality of retractable steps from the stowed position to the deployed position in less than five seconds from generation of the emergency egress signal.

11. The system of claim 1, wherein the plurality of retractable steps are integrated with a rear bumper assembly of the school bus, and wherein in the stowed position the plurality of retractable steps are substantially concealed within or beneath the rear bumper assembly.

12. The system of claim 1, further comprising status indicators visible from a driver position indicating at least one of: a deployed state, a stowed state, or an error condition.

13. A method for facilitating emergency egress from a rear emergency door of a school bus, the method comprising:
generating an emergency egress signal in response to at least actuation of a latch mechanism of the rear emergency door;
deploying a plurality of retractable steps from a stowed position to a deployed position via a continuous drive actuator in response to the emergency egress signal; and
retracting the plurality of retractable steps from the deployed position to the stowed position upon termination of the emergency egress signal.

14. The method of claim 13, wherein generating the emergency egress signal comprises completing an electrical circuit via a door latch sensor upon actuation of the latch mechanism, thereby supplying electrical power to the continuous drive actuator.

15. The method of claim 13, wherein the emergency egress signal is generated before the rear emergency door has substantially opened from a closed position.

16. The method of claim 13, wherein generating the emergency egress signal comprises evaluating, via a control system, at least one of ignition status information or transmission status information of the school bus prior to permitting deployment.

17. The method of claim 16, wherein the control system generates the emergency egress signal when the ignition status information indicates ignition is off, or when the ignition status information indicates ignition is on and the transmission status information indicates the transmission is not engaged in a driving gear.

18. The method of claim 16, wherein the control system inhibits generation of the emergency egress signal when the ignition status information indicates ignition is on and the transmission status information indicates the transmission is engaged in a driving gear.

19. The method of claim 13, further comprising receiving a manual override input from a driver position and generating the emergency egress signal in response to the manual override input.

20. A school bus comprising:
a rear emergency door having a latch mechanism;
a switch in electrical communication with the latch mechanism, the switch configured to change state upon actuation of the latch mechanism;
retractable steps positioned beneath the rear emergency door and configured to transition between a stowed position concealed within or beneath a rear bumper assembly and a deployed position extending toward a ground surface;
circuitry electrically connected to the switch and configured to generate an emergency egress signal in response to the change of state of the switch; and
an actuator configured to deploy the retractable steps in response to the emergency egress signal and retract the retractable steps upon termination of the emergency egress signal.
